(19) United States
(12) Patent Application Publication
(10) Pub. No.: US 2021/0039915 A1
(43) Pub. Date: Feb. 11, 2021

(54) EXECUTION OF PRINT COMMANDS

(71) Applicant: Hewlett-Packard Development Company, L.P., Spring, TX (US)

(72) Inventors: Tong Nam Samuel Low, Singapore (SG); Yu Zhao, Singapore (SG); Pui Wen Huang, Singapore (SG); Yew hin Liew, Singapore (SG); Wei Chun Lim, Singapore (SG)

(21) Appl. No.: 17/046,138

(22) PCT Filed: Apr. 20, 2018
(86) PCT No.: PCT/US2018/028511

§ 371 Date: Oct. 8, 2020

(51) Int. Cl. B65H 43/06; B65H 7/14

(52) U.S. Cl. CPC B65H 43/06; B65H 7/14; B65H 2511/30; B65H 2511/13; B65H 2511/152

(57) ABSTRACT

Examples techniques to control execution of print commands are described. In an example, a print command indicative of markings to be on a medium is received at an image rendering device. A number of ink droplets to be ejected from nozzles of the image rendering device to form the markings on the medium is determined. A thickness that the medium will have upon the markings being formed is determined based on the number of ink droplets to be ejected from the nozzles. The print command is executed based on the estimated thickness.

### BACKGROUND

Image rendering devices, such as printers, scanners and photocopying devices may render content onto a medium. The image rendering devices may print a variety of contents on different types of media. Various data, such as textual data, graphical data can be printed on media comprising paper, cloth, and resin.

The medium on which the content is to be printed is provided in an input tray of image rendering device. When a user initiates a print command containing the content to be printed, the image rendering device executes the print command to form markings on the medium to render the content on the medium. To carry out the image rendering process, the medium may be fetched from the input tray, and conveyed through the image rendering device for rendering the content. The printed medium is collected on an output tray of the image rendering device.

### BRIEF DESCRIPTION OF FIGURES

The following detailed description references the drawings, wherein:

FIG. 1 illustrates an image rendering device, in accordance with an example implementation of the present subject matter;

FIG. 2 illustrates an image rendering device, in accordance with another example implementation of the present subject matter;

FIG. 3 illustrates a cross-section of an output tray of an image rendering device, in accordance with an example implementation of the present subject matter;

FIGS. 4a and 4b schematically represent a short grain medium and a long grain medium, respectively, in accordance with an example implementation of the present subject matter;

FIG. 5 illustrates a method to control execution of a print command, in accordance with an example implementation of the present subject matter;

FIG. 6 illustrates a method to control execution of the print command, in accordance with another example implementation of the present subject matter; and

FIG. 7 illustrates a computing environment to control execution of the print command, in accordance with an example implementation of the present subject matter.

### DETAILED DESCRIPTION

Image rendering devices, such as printers, scanners, photocopiers, are used to print various types of content, ranging from complex graphical image to simple plain text, that can be printed on different types of media, such as paper, cardboard, and plastic sheets having various thickness can be used. An image rendering device has an input tray where the media may be stored for printing. To execute a print command, the image rendering device retrieves a medium from the input tray to print content in accordance with the print command on the medium. The printing results in formation of markings in accordance with the print command on the medium. The image rendering device thereafter outputs the printed medium on an output tray of the image rendering device for a user to collect the printed medium.

In some cases, the user may not collect the printed medium from the output tray and printed media may keep accumulating on the output tray. In general, the output tray of an image rendering device has a fixed capacity for accommodating the printed media. In other words, the output tray can accommodate the printed media up to a predetermined stack height. In case the output tray is not emptied after the accumulated printed media reaches a predetermined stack height, the output tray may not accommodate further incoming printed media and some of the printed media may spill out, for instance, on the floor resulting in damage to the printed media. Further, depending on the type of content being printed on the medium and the stack height of the printed media on the output tray, a medium undergoing printing may get jammed inside the image rendering device. Accordingly, in some cases, an image rendering device may stop executing print commands based on a determination that the output tray is full.

The image rendering device may implement various techniques to determine the stack height of the printed media on the output tray. Once the stack height is determined, the image rendering device may estimate the number of printed media that may be further accommodated on the output tray before the predetermined stack height is attained. This estimation is generally based on the thickness of the medium being used for the printing. The image rendering device takes into account the thickness of the single medium and accordingly determines the stack height of the printed media and the number of printed media that the output tray can further accommodate. The image rendering device, however, does not takes into account the variation in thickness of a printed medium due the content being printed.

Since the thickness of a printed medium varies based on the content printed on the medium, for example, the thickness of the printed medium increases when the content contains more graphical diagrams as compared to plain text, the image rendering device may inaccurately determine the thickness of the printed medium. As a result, the number of printed media that can be accommodated on the output tray, may be inaccurately estimated. In such cases, if the print command is executed, the output tray would not be able to accommodate the incoming printed medium.

According to an example implementation of the present subject matter, techniques for execution of print commands based on estimation of the thickness of a medium are described. Example methods and devices provide for accurate estimation of the thickness that the medium will have upon the content being printed on the medium based on a print command. The execution of the print command may be stopped or delayed if, based on the estimated thickness, it is determined that an output tray of an image rendering device cannot accommodate further printed media.

In an example implementation, a print command comprising print data usable by an image rendering device to form markings on a medium is received at the image rendering device. A density of markings to be formed on the medium is determined. The density of the markings is determined based on number of ink droplets that would be ejected from the image rendering device onto the medium based on the print data. Based on the density of the markings, the thickness that the medium will have upon forming of the markings on the medium is estimated. The execution of the print command is controlled based on the estimation.

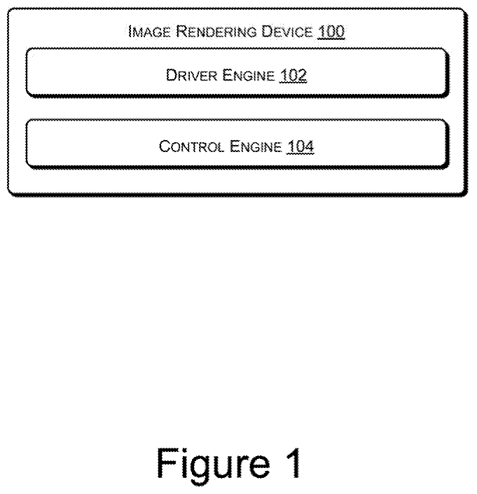

The above techniques are further described with reference to FIG. 1 to FIG. 7. It should be noted that the description and the figures merely illustrate the principles of the present subject matter along with examples described herein and should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 shows an image rendering device 100, according to an example implementation of the present subject matter. Examples of the image rendering device 100 include, but are not limited to, printers, scanners, photocopier, and all such devices which form or print markings on a medium. Examples of medium include, paper, cloth, plastics, and fabric. In an example, the image rendering device 100 has an input tray (not shown) from where the medium is fetched for printing and the further, the printed medium is collected on an output tray (not shown) of the image rendering device 100.

According to an implementation of the present subject matter, a driver engine 102 of the image rendering device 100 receives a print command. The print command is indicative of print data usable by the image rendering device 100 to form markings on a medium, such as a sheet of paper. The driver engine 102 analyzes the print data of the print command and determines the number of ink droplets that are to be ejected onto the medium to form the markings. In an example implementation, the ink droplets are ejected via nozzles of the image rendering device 100 and are deposited on the medium resulting in formation of the markings in accordance with the print data on the medium. As will be apparent, in examples where the print command comprises print data to be utilized by the image rendering device 100 to form the markings on multiple sheets of paper, the driver engine 102 determines the number of ink droplets that are to be ejected or fired onto each such sheet.

Based on the number of ink droplets to be fired for forming the markings on the medium, a control engine 104 of the image rendering device 100 estimates a thickness that the medium will have after the markings are formed onto the medium. The estimation may be made for each of the media onto which the markings are to be formed for execution of the print command.

In an example, the control engine 104 also determines a stack height of printed media available on the output tray of the image rendering device 100. As will be understood, the printed media may accumulate on the output tray of the image rendering device 100 from print commands previously executed by the image rendering device 100. Techniques that may be employed by the control engine 104 for determining the stack height will be described in further detail hereinafter.

Based on the estimated thickness and the determined stack height, the control engine 104 ascertains if the printed medium that would result from the execution of the presently received print command can be accommodated on the output tray. Again, as may be apparent based on the print data in the print command, the print command may result in a printed medium or multiple printed media. The control engine 104 executes the print command if it is ascertained that the printed medium or printed media can be accommodated on the output tray of the image rendering device 100. However, if the control engine 104 ascertains that the printed medium or printed media cannot be accommodated on the output tray, the print command may not be executed. This provides for avoiding situations where printed media is spilled out from the output tray due to unavailability of space on the output tray, thus, avoiding damaging of the printed medium. Also, situations like jamming of the medium undergoing printing may be avoided.

Further, since the present subject matter takes the thickness of the medium, based on the content being printed, into account, the estimation of the thickness of the medium and in turn the determination of printed media that can be accommodated on the output tray is accurate. Accordingly, situations where the printing is delayed due to estimation of unavailability of space on the output tray may also be avoided.

It is noted that the driver engine 102 and the control engine 104 are illustrated separately merely to simplify explanation. In some cases, the driver engine 102 and the control engine 104 may be combined or functionality may be shared differently than as described herein.

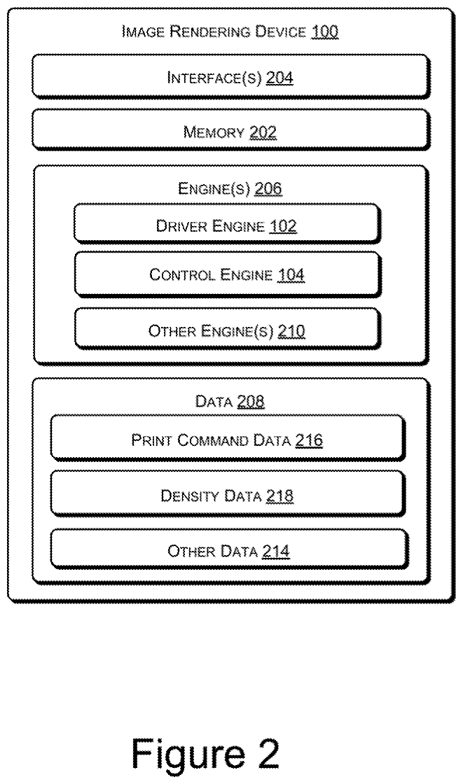

FIG. 2 illustrates an image rendering device 100, in accordance with another example implementation of the present subject matter.

The image rendering device 100, among other things, includes a memory 202, interface(s) 204, and engine(s) 206. The memory 202 may include any computer-readable medium including, for example, volatile memory (e.g., RAM), and/or non-volatile memory (e.g., EPROM, flash memory, etc.). The interface(s) 204 may be used to provide inputs to the image rendering device 100. The examples of inputs may include user credentials, biometric credentials, etc. for the image rendering device 100 to perform a function, such as execution of a print command.

The engine(s) 206 may be implemented as a combination of hardware and programming (for example, programmable instructions) to implement certain functionalities of the engine(s) 206, such as estimating a thickness that a medium will have upon formation of markings based on a print command. In examples described herein, such combinations of hardware and programming may be implemented in several different ways. For example, the programming for the engine(s) 206 may be processor executable instructions stored on a non-transitory machine-readable storage medium and the hardware for the engine(s) 206 may include a processing resource (for example, implemented as either a single processor or a combination of multiple processors), to execute such instructions. In the present examples, the machine-readable storage medium may store instructions that, when executed by the processing resource, implement engine(s) 206. In such examples, the image rendering device 100 may include the machine-readable storage medium storing the instructions and the processing resource to execute the instructions, or the machine-readable storage medium may be separate but accessible to image rendering device 100 and the processing resource. In other examples, engine(s) 206 may be implemented by electronic circuitry. The engine(s) 206 may also comprise other engine(s) 210 that supplement functions of the image rendering device 100. In an example, the engine(s) 206 include the driver engine 102 and the control engine 104.

The data 208 serves, amongst other things, as a repository for storing data that may be fetched, processed, received, or generated by the engine(s) 206. The data 208 comprises other data 214 corresponding to the other engine(s) 210. In the illustrated example implementation, the data 208 of the image rendering device 100 also comprises print command data 216 and data 218.

In operation, the driver engine 102 receives a print command indicating print data usable for forming markings on a medium. The markings may be formed on a medium or multiple media, as explained above. The explanation hereinafter is provided in context of markings being formed on a single medium. The explanation extends mutatis mutandis to cases where the markings may be formed on multiple media as well. In an example implementation, the print data pertaining to the received print command may be stored in the print command data 216. For example, the print data may be stored such that the execution of the print command is delayed until a determination, as to whether the space available on an output tray would accommodate the printed medium that would result upon the execution of the print command, is made.

The driver engine 102 retrieves the print data stored in the print command data 216 and analyzes the same to determine the number of ink droplets that are to be fired in order to form the markings onto the medium. The image rendering device 100 comprises array of nozzles which eject ink droplets to form the markings on the medium. The nozzles are actuated by the driver engine 102 based on the markings to be formed. For example, for printing a letter ‘A’, the nozzles are actuated such that the ejected ink droplets from those nozzles are deposited in the shape of letter ‘A’. As the nozzles are actuated and the ink droplets ejected from the nozzles deposit themselves on the medium, the bulk of the medium increases.

Based on the number of ink droplets that are to be ejected, in an example, the driver engine 102 determines the density of the markings to be formed. In cases where multiple media are to be printed for executing the print command, the driver engine 102 determines, for each of the media, the number of ink droplets that are to be fired from the image rendering device 100 to form the markings on the respective medium. A print command that results in more number of ink droplets to be fired, has higher density of the markings to be formed, or simply density, as compared to a print command that would have lesser number of ink droplets fired. In an example, the data may be stored in the data 218.

The number of ink droplets to be ejected and in turn density depends on the type of the markings to be formed or printed. For example, for forming markings of a graphical image a large numbers of ink droplets may be fired as compared to formation of markings of a plain text. In another example, the content to be printed may comprise high contrast regions such that dark portions of the high contrast regions may be formed by depositing multiple layers of ink droplets. The multiple layers of ink droplets resulting from high density may result in the thickness of the medium to increase. In an example, a medium printed with several layers of ink droplets may be three to five times as thick as a corresponding unprinted medium.

The control engine 104 determines the estimated thickness that the medium will have after the data is printed on the medium based on the density of the markings. For example, the control engine 104 may be aware of thickness of the unprinted medium by assessing the same or based on a user input. To this thickness of the unprinted medium, the thickness that may be added by virtue of the multiple layers of ink droplets that may be deposited based on the density, is added to get the estimated thickness that the medium will have after the markings are formed.

In an example, the driver engine 102 may also determine if the markings are to be formed on both sides of the medium, i.e., duplex printing or the on single side, i.e., simplex printing of the medium to estimate the thickness. Accordingly, based on print settings of the image rendering device 100, whether simplex or duplex, the driver engine 102 may determine the density of the markings to be formed on each or both sides of the medium.

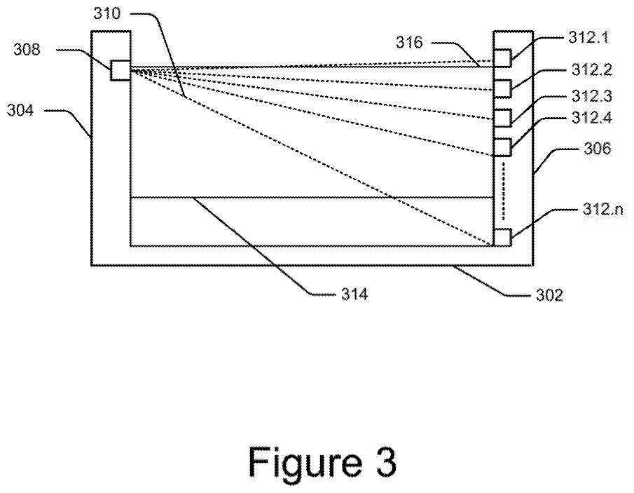

In an example implementation, the control engine 104 may also determine a stack height of the media already present on the output tray of the image rendering device 100. The mechanism for determining the stack height will be explained hereinafter with reference to FIG. 3. The media may have accumulated on the output tray due to previously executed print commands. Determination of stack height of the media on the output tray provides for determining the space available on the output tray to accommodate the printed medium that would be accumulated as result of executing the print command. As mentioned previously, the output tray of the image rendering device 100 can accommodate media up to a predetermined stack height and thus, determining the stack height of the already present media indicates the space available to accommodate further printed media.

Thus, based on the estimated thickness of the medium and the stack height, the control engine 104, determines if the medium, when printed, can be accommodated on the output tray of the image rendering device 100. If the control engine 104 determines that the printed medium or printed media can be accommodated on the output tray, the print command in executed. On the other hand, if the control engine 104 determines that the printed medium cannot be accommodated, the control module 104 may delay the execution of the print command until the output tray has been cleared.

In an example, upon determining that the printed medium cannot be accommodated on the output tray, the control engine 104 may generate a notification. The notification, for instance, may be displayed on a display of the image rendering device 100 to alert the user that the print command may not be executed as there is lack of space on the output tray to accommodate the printed medium. In an example, the notification may also be an audio alert, such as a ‘beep’ sound, indicating that the execution of the print command is pending an action on part of the user resulting in space on the output tray being made available to accommodate the printed medium.

FIG. 3 shows a cross section of an output tray 302 of the image rendering device 100. The figure shows a U-shaped cross-section of the output tray 302 on which the printed media is accumulated. A first side column 304 of the output tray 302 houses an emitter 308 that emits a radiation 310. In an example, the radiation 310 may be infrared radiation (IR) or radiations in the visible spectrum having wavelength in range of about 400 nanometers to 1 millimeters. In an example, the emitter 308 is housed such that the emergence of radiation 310 from the emitter 308 is not blocked by the media, if any, present on the output tray 302. In an example, the emitter 308 is positioned on the first side column 304 such that the height at which the emitter 308 is positioned corresponds to a maximum stack height of media that may be accommodated on the output tray 302. Also, in an example, the emitter 308 is positioned to emit the radiation 310 towards a second side column 306 of the output tray 302 such that the emitted radiation 310 is directed towards an array of receivers 312.1-312.n housed in the second side column 306 along the height of the second side column 306.

In operation, the array of receivers 312.1-312.n detects the radiation 310 and provides an output to the control engine 104. To determine the stack height of media present on the output tray 302, the control engine 104 analyzes which of the receivers in the array of receivers 312.1-312.n have received the emitted radiation 310. For example, when the stack height of the media on the output tray 302 has reached at a first level 314, the radiation 310 directed towards the receiver 312.n located at the base of the second side column 306 is blocked and the control engine 104, by analyzing the output of receiver 312.n which indicated non-receipt of the emitted radiation 310, determines that the stack height of the outputted media has reached the first level 314.

In the example, the maximum stack height of the media on the output tray 302 is indicated by a second level 316. In an example, when the stack height is at the first level 314, the control engine 104 determines the difference in height of the first level 314 and second level 316 on the output tray 302 and accordingly determines the space available on the output tray 302 for accommodating the further printed media. However, when the stack height of media on the output tray 302 reaches the second level 316, the radiation 310 towards the receiver 312.1 is blocked, the control engine 104 determines that the maximum stack height of media is reached.

To use an example for illustration, it may be assumed that the difference in height of the first level 314 and the second level 316 on the output tray 302, which is indicative of the space available to accommodate the further printed medium, corresponds to thickness of 200 unprinted media. In other words, the available space may accommodate 200 unprinted media. Accordingly, in an example, where the further media are printed with low density, not resulting in significant variation in the thickness of the media, the number of media that may be further accommodated may be 200. However, in cases where the further media are printed with high density of content, each of the media or a large proportion of the media may result in having a thickness corresponding three to five times as that of the unprinted media. Accordingly, the number of media that may be further accommodated may be significantly lower than 200. For instance, the number of media that may be further accommodated may be 200/3 or 200/5 depending on the density and in turn the estimated thickness. Thus, the control engine 104, based on the number of media that can be further accommodated on the output tray 302, determines if the print command is to be executed or not. In an example, a notification may be generated when the print command is not to be executed.

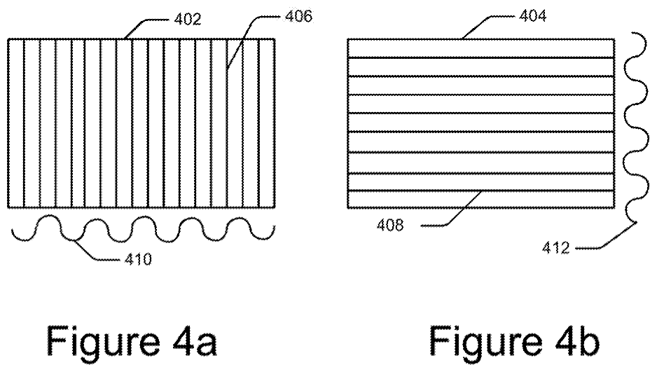

FIGS. 4a and 4B schematically represent a short grain medium and a long grain medium respectively, in accordance with an example implementation of the present subject matter. Reference is made to FIGS. 4a and 4B to discuss the effect of grain orientation on the thickness of a medium, such as a sheet of paper. A medium is a collection of large number of individual fibers of material the medium is made up of. The fibers are arranged in either long grain or short grain configuration. FIG. 4a illustrates a first medium 402 having a short grain configuration and FIG. 4b illustrates a second medium 404 having a long grain configuration. In the short grain configuration, the fibers 406 of the first medium 402 are arranged parallel to the shorter side, i.e., the width of the first medium 402, as shown in FIG. 4a, and in the long grain configuration, the fibers 408 of the second medium 404 are arranged parallel to the longer side i.e., the length of the second medium 404, as shown in the FIG. 4b.

During formation of the markings on the medium, the medium 402 and 404 is subjected to a pressure. The pressure may be applied by various components of image rendering device 100, such as a printhead (not shown in figures) of the image rendering device 100 or rollers (not shown in figures) of the image rendering device 100. When the pressure is applied on a medium in a direction perpendicular to the grain orientation of the medium, the medium curls itself. The direction of curling depends on the grain orientation of the medium. For example, the first medium 402, having short grain configuration, may tend to curl in a first pattern 410 as shown in the FIG. 4a and the second medium 404, having long grain configuration, may curl in a second pattern 412 shown in the FIG. 4b.

Due to the curling of the medium, a single medium may consume space of multiple medium. For example, the first medium 402 or second medium 404, if curled, may occupy space of up to three to five media that is not curled. In another example, a curled first medium 402 or a curled second medium 404 may occupy space of more than five media that is not curled. Accordingly, in an example implementation, the control engine 104 may estimate the thickness of the medium based on curling of the medium in addition to the density of the markings to be printed. Thus, the control engine 104 may estimate the number of printed media that may be accommodated on the output tray 302 based on the curling of the medium would undergo upon the markings being formed or printed.

Consider an example where the control engine 104 may, based on the thickness estimated in accordance with the density alone, determine that 20 printed media may be accommodated on the output tray 302. However, since curling of the medium may cause medium to consume the space of, in some cases, up to five media, four or less (20/5, in case curling consumes space of five media which is not curled) media may be accommodated on the output tray 302 in the present example. Thus, the control engine 104, in an example, analyzes the effect of grain orientation and curling of the medium in addition to the density of the markings, to estimate the number of the media that may be accommodated after being printed and control the execution of the print command accordingly.

To determine whether a medium would undergo curling, in one example, the control engine 104 determines the direction in which the pressure would be applied on a medium during the forming of the markings. The control engine 104 also determines the grain orientation of the medium. In an example, the control engine 104 may use an optical media advance sensor (OMAS) to determine the grain orientation. The OMAS takes high definition images of a medium and the control engine 104 may use these high definition images to determine the grain orientation of the medium. In another example, the control engine 104 may determine the grain orientation of the medium based on a user input. When the control engine 104 determines that the pressure would be applied in a direction perpendicular to the grain orientation of the medium, the control engine 104 determines that the medium would curl upon being printed and accordingly estimates the thickness of the medium.

In an example scenario, when the control engine 104 is unable to determine the grain orientation of the medium, the control engine 104 may, by default, consider that the medium would curl upon being printed and estimate the thickness taking the curling into account in addition to the density of the markings to be printed.

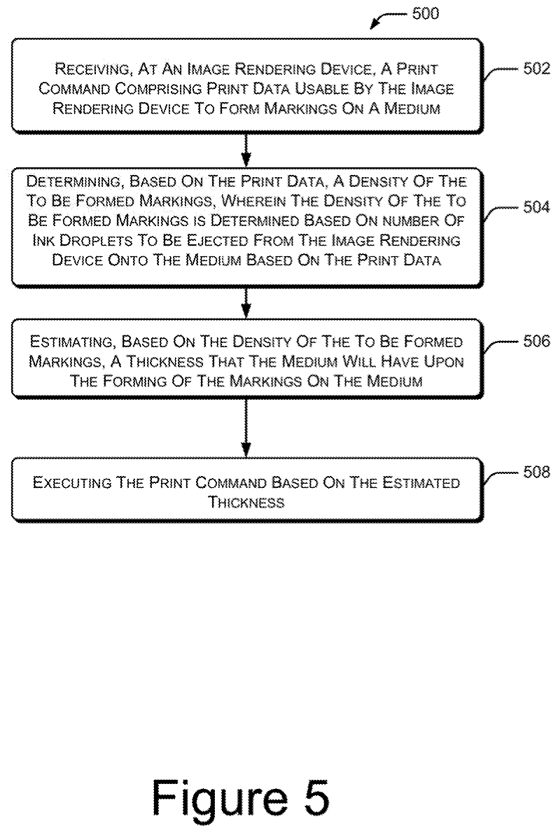

FIG. 5 illustrates a method 500 for executing a print command by an image rendering device 100, according to an example implementation of the present subject matter. Although the method 500 and may be implemented in a variety of image rendering device, for the ease of explanation, the present description of the example method 500 to control the execution of print command is provided in reference to the above-described image rendering device 100.

The order in which the method 500 is described is not intended to be construed as a limitation, and any number of the described method blocks may be combined in any order to implement the method 500, or an alternative method.

It may be understood that blocks of the method 500 may be performed by the image rendering device 100. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 5, at block 502, a print command is received by an image rendering device. For example, the print command may be received by the driver engine 102 of the image rendering device 100. The print command comprises the print data usable by the image rendering device to form markings on a medium. In an example, the print data may a textual data, an image, graphical data, etc. . . .

At block 504, the driver engine 102 determines the density of the markings to be formed. As explained earlier, the density of the markings is determined based on the number of ink droplets to be fired from the nozzles of the image rendering device 100 to form the markings.

At block 506, a control engine, such as control engine 104 of the image rendering device 100 estimates the thickness that the medium will have upon the markings being printed. As mentioned previously, the thickness of the medium varies based on the type of markings to be printed on the medium. For example, a medium to be printed with images will have more thickness as compared to a medium to be printed with primarily textual content. The control engine 104 estimates the thickness of each of the medium, in case multiple medium are to be printed to execute the print command.

After estimating the thickness, the method proceeds to block 508, where the control engine 104 executes the print command based on estimated thickness. The control engine 104 executes the print command if it is ascertained that the printed medium or printed media, as the case may be can be accommodated on the output tray 302 of the image rendering device 100. However, if the control engine 104 ascertains that the printed medium or printed media cannot be accommodated on the output tray 302, the print command may not be executed to prevent situations where the printed media may spill outside the output tray 302 or where the medium being printed is jammed in the image rendering device.

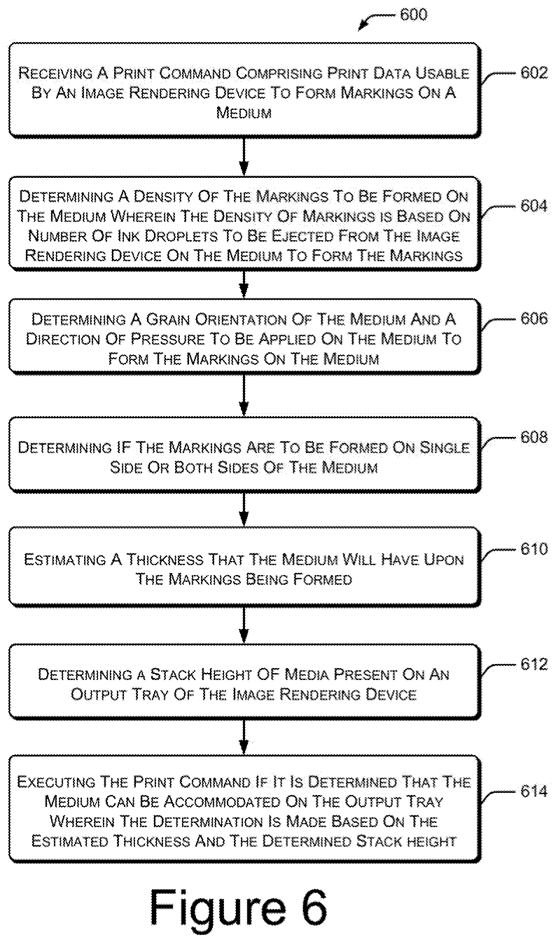

FIG. 6 illustrates a method 600 for executing the print command by an image rendering device 100, according to an example implementation of the present subject matter. Although the method 600 and may be implemented in a variety of image rendering device, for the ease of explanation, the present description of the example method 600 to control the execution of print command is provided in reference to the above-described image rendering device 100.

The order in which the method 600 is described is not intended to be construed as a limitation, and any number of the described method blocks may be combined in any order to implement the method 600, or an alternative method.

It may be understood that blocks of the method 600 may be performed by image rendering device. The blocks of the method 600 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 6, at block 602, a print command is received by the driver engine 102 of the image rendering device 100. At block 604, based on the number of ink droplets to be fired to form markings in accordance with the print command on the medium, the driver engine 102 determines the density of the markings to be formed.

At block 606, the control engine 104 determines the grain orientation of the medium and the direction of a pressure to be applied on the medium to form the markings. As explained earlier, the thickness of the medium varies due to curling of the medium which occurs based on the direction of pressure applied on the medium and the grain orientation of the medium.

At block 608, the driver engine 102 determines if the markings are to be printed on both sides, i.e., duplex printing of the medium or single side, i.e., simplex printing of the medium. As understood, the thickness of the medium will vary based on markings being formed on both sides or markings being formed on single side. Thereafter, the method proceeds to block 610.

At block 610, the control engine 104 determines the thickness that the medium will have upon the data being printed. The control engine 104 determines the thickness based on number of ink droplets to be ejected to form the markings, simplex printing or duplex printing and the grain orientation.

At block 612, the control engine 104, further determines the stack height of the media already present on the output tray 302 of the image rendering device 100. As explained earlier, stack height is determined to analyze the space available on the output tray 302 for accommodating the printed medium that would accumulate on the output tray 302 as result of execution of the print command. Thereafter, the method proceeds to block 614 where the control engine 104 executes the print command based on the estimated thickness of the medium and the stack height.

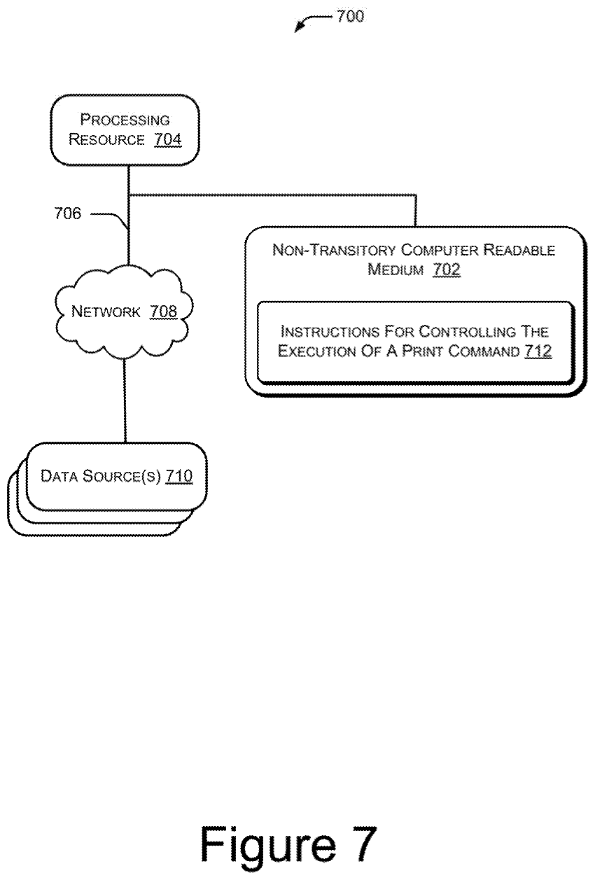

FIG. 7 illustrates a computing environment 700 implementing a non-transitory computer-readable medium 702 for controlling execution of a print command, according to an example of the present subject matter. In an example implementation, the computing environment 700 may comprise an image rendering device, such as image rendering device 100. The computing environment 700 includes a processing resource 704 communicatively coupled to the non-transitory computer-readable medium 702 through a communication link 706. In an example, the processing resource 704 may be a processor of the image rendering device, such as the processor 200 of the image rendering device 100, that fetches and executes computer-readable instructions from the non-transitory computer-readable medium 702.

The non-transitory computer-readable medium 702 can be, for example, an internal memory device or an external memory device. In an example implementation, the communication link 706 may be a direct communication link, such as any memory read/write interface. In another example implementation, the communication link 706 may be an indirect communication link, such as a network interface. In such a case, the processing resource 704 can access the non-transitory computer-readable medium 702 through a network 708. The network 708 may be a single network or a combination of multiple networks and may use a variety of different communication protocols.

The processing resource 704 and the non-transitory computer-readable medium 702 may also be communicatively coupled to data sources 710. The data source(s) 710 may be used to store the print command, density of data, stack height, in an example. In an example implementation, the non-transitory computer-readable medium 702 comprises executable instructions 712 for controlling execution of the print command by the image rendering device 100. For example, the non-transitory computer-readable medium 702 may comprise instructions executable to implement the previously described driver engine 102 and control engine 104.

In an example, the instructions 712 cause the processing resource 704 to detect a print command received by an image rendering device and obtain a print data contained within the print command. As apparent from the previous description, the print data may include any textual data, graphical data, and image data and wherein the print data is usable by the image rendering device to form markings on a medium. Thereafter, the instructions 712 cause the processing resource 704 to determine the number of ink droplets to be fired on a medium by the image rendering device to form markings on the medium.

Further, the instructions 712 cause the processing resource 704 to determine the grain orientation of the medium and a direction of pressure to be applied on the medium, by the image rendering device, during formation of the markings on the medium. The curling of the medium depends on the direction of applied pressure which results in variation of thickness of printed medium. Thereafter, the instructions 712 cause the processing resource 704 to estimate the thickness the medium will have after the markings are formed on the medium, wherein the thickness is estimated based on the number of ink droplets to be fired and the grain orientation.

In an example, instructions 712 may cause the processing resource 704 to determine the stack height of the media already present on an output tray 302 of the image rendering device 100. This helps in determining the space available, on the output tray 302 of the image rendering device 100, to accommodate the printed medium that would arrive on the output tray 302 as a result of execution of the print command. Further, in an example, instructions 712 may cause the processing resource 704 to control execution of the print command based on the estimated thickness as well as the determined stack height. If it is determined that the printed medium may be accommodated, the instructions 712 may cause the print command to be executed. However, in cases where the estimation reveals that the printed medium may not be accommodated, the instructions 712 may cause generation of a notification. In an example, the notification may indicate that the execution of the print command is pending an action that may create space on the output tray 302 of the image rendering device 100.

Thus, the methods and devices of the present subject matter provide for controlling the execution of the print command. Although implementations of controlling the execution of the print command have been described in a language specific to structural features and/or methods, it is to be understood that the appended claims are not necessarily limited to the specific features or methods described. Rather, the specific features and methods are disclosed as example implementations for controlling the execution of the print command.

We claim:

1. A method comprising:
receiving, at an image rendering device, a print command comprising print data usable by the image rendering device to form markings on a medium;
determining, based on the print data, a density of the to be formed markings, wherein the density of the to be formed markings is determined based on a number of ink droplets to be ejected from the image rendering device onto the medium;
estimating, based on the density of the to be formed markings, a thickness that the medium will have upon forming the markings on the medium; and
executing the print command based on the estimated thickness.

2. The method as claimed in claim 1, wherein estimating the thickness that the medium will have upon the markings being formed further comprises determining a grain orientation of the medium.

3. The method as claimed in claim 1, wherein estimating the thickness that the medium will have upon the markings being formed further comprises determining a direction of pressure to be applied on the medium, by the image rendering device, to form the markings on the medium.

4. The method as claimed in claim 1, wherein the method further comprises:
determining a stack height of media present on an output tray of the image rendering device; and
controlling the execution of the print command based on the determined stack height.

5. The method as claimed in claim 1, wherein the method further comprises determining the print command to be one of simplex and duplex.

6. An image rendering device comprising:
a driver engine to:
receive a print command indicative of markings to be formed on a medium; and
determine a number of ink droplets to be fired onto the medium to form the markings; and
a control engine to:
determine a stack height of media on an output tray of the image rendering device;
estimate a thickness that the medium will have upon the markings being formed based on the number of ink droplets to be fired onto the medium; and
control an execution of the print command based on estimated thickness and the determined stack height.

7. The image rendering device as claimed in claim 6, wherein the control engine is coupled to:
an emitter to emit a radiation; and
a receiver to detect the radiation emitted by the emitter,
the emitter and the receiver being placed on either side of the output tray of the image rendering device.

8. The image rendering device as claimed in claim 6, wherein the control engine is to determine a grain orientation of the medium, wherein the grain orientation is one of a short grain and a long grain.

9. The image rendering device as claimed in claim 8, wherein the control engine is to estimate the thickness to be equal to three to five times the thickness of the medium when the grain orientation of the medium is perpendicular to a direction of pressure to be applied on the medium, by the image rendering device, to form the markings on the medium.

10. The image rendering device as claimed in claim 6, wherein the control engine is to generate a notification when the print command is not executed.

11. A non-transitory computer-readable medium comprising instructions executable by a processing resource to:
detect a print command received by an image rendering device wherein the print command comprises print data, the print data usable by the image rendering device to form markings on a medium;
determine a number of ink droplets to be fired onto the medium to form the markings on the medium;
determine a grain orientation of the medium;
estimate a thickness that the medium will have upon the forming of the markings based on the number of ink droplets and the determined grain orientation; and
control an execution of the print command based on estimated thickness.

12. The non-transitory computer-readable medium as claimed in claim 11, further comprising instructions executable to determine a direction of pressure to be applied on the medium, by the image rendering device to form the markings on the medium.

13. The non-transitory computer-readable medium as claimed in claim 12, further comprising instructions executable to determine, based on the grain orientation of the medium and the direction of the pressure, a direction of curling of the medium upon the markings being formed.

14. The non-transitory computer-readable medium as claimed in claim 11, further comprising instructions executable to determine a stack height of media present on an output tray of the image rendering device.

15. The non-transitory computer-readable medium as claimed in claim 14, further comprising instructions executable to calculate, based on the estimated thickness and the determined stack height, space available on the output tray to accommodate the medium upon the markings being formed.
